(19) United States
(12) Patent Application Publication
(10) Pub. No.: US 2008/0092850 A1
(43) Pub. Date: Apr. 24, 2008

(54) Hydraulically Driven Pump-Injector With Controlling Mechanism For Internal Combustion Engines

(76) Inventor: Boris Feinleib, Jerusalem (IL)

Correspondence Address: NATH & ASSOCIATES, 112 South West Street, Alexandria, VA, 22314, US

(21) Appl. No.: 11/658,031

(22) PCT Filed: Jul. 20, 2004
(86) PCT No.: PCT/IL04/00656

§ 371 Date: Jan. 22, 2007

(51) Int. Cl. F02M 57/02; F02M 59/00

(52) U.S. Cl. 123/445; 239/92; 417/392

(57) ABSTRACT

Hydraulically driven pump-injector with controlling mechanism for internal combustion engines, primarily for diesel, distinguished via the fact that in the pump-injector body (1) above needle (9) additional cylindrical cavity (69) is made, in which locking piston (8) is mounted, resting upon needle (9), the diameter of said additional cavity and hence the piston diameter being selected on the basis of the formulae disclosed in the invention. Space (24) formed above the piston face is periodically connected through distribution channel (25) and valve (33) of the distributing device to the source of the actuating fluid and the drain tank, alternately. This ensures a decrease in the delay of the operation on the nozzle needle compared to the signal from the electronic control unit (travel of the valve of the distributing device), required for obtaining small time delays between the injections in multiphase injection, as well as increased stability of the idle running of the engine. In accordance with the invention, penetration of gases from the combustion chamber to the fuel system and leaking of fuel into the combustion chamber when the nozzle needle “hangs”, or “freezes” in it's upper open position, are also prevented due to the fact that the fuel (actuating fluid) is supplied to the under-plunger cavity (19) through central channel (33) in the body, which stops locking piston (8) of needle (9) when the latter “hangs”. The invention also allows for increasing average injection pressures and implementing “rate shaping”.

### TECHNICAL FIELD

The invention relates to the field of fuel supply systems for internal combustion engines, specifically to diesels and, more specifically, to their hydraulically driven pump-injectors.

### BACKGROUND ART

In conventional hydraulically driven pump-injectors comprising a piston-type pressure intensifier, a distributing device with a valve, and a sprayer unit (nozzle), the time of opening the nozzle, and consequently the volume fuel delivery, is not directly connected to the time of opening the valve of the distributing device. In such devices, the valve normally has an electromagnetic, piezoelectric or a different type of a drive, controlled via a signal from the electronic control unit, and the duration of this signal, i.e. the time, during which the valve remains open, determines the value for the volume fuel delivery. The absence of direct correlation between the controlling signal (the travel of the valve) and the nozzle operation in conventional hydraulically driven pump-injectors is caused via relatively long (compared to the travel of the valve of the distributing device controlled via the signal from electronic control unit) delay of the operation of the hydromechanical device activating the pumping plunger, the pressure under which in above-plunger space determines the nozzle operation (the moments of the lifting and seating of the nozzle needle on the seat of the body). This phenomenon is especially noticeable in hydraulically driven pump-injectors in large cylinder diesels having accordingly high volume fuel delivery (2500 mm³ and more), used in heavy off roads, locomotives, marine applications and power generators. In hydraulically driven pump-injectors for such diesels, double-stage distributing devices must be used comprising the first stage—an electronically controlled valve with relatively small cross section controlling the second stage of the distributing device—a hydraulically driven valve with large cross section, controlling directly the feeding of the actuating fluid to the hydraulically driven power piston of the pressure intensifier. Due to the absence of direct correlation between the controlling signal (the travel of the first-stage valve) and the moment of activation of the entire distributing device and accordingly, of the pressure intensifier, it is impossible to decrease the time delay between two successive injections to 0.001-0.0015 Sec., as required for implementing double-phase or multiphase injection, normally used for increasing durability, and reducing noise, specific fuel consumption, and especially emission levels.

In addition, said loss of control of the beginning and end of the fuel injection does not allow for obtaining stable low volume fuel deliveries (for instance, 50-100 mm³ when maximum volume fuel delivery is 2500 mm³), required for efficient idle operation of the diesels.

A significant drawback of conventional hydraulically driven pump-injectors which is also characteristic of other fuel system designs (including separate-type systems, high pressure “common rail” systems, and systems with pump-injectors having mechanically driven plungers), is the possible large leakage of fuel into the combustion chamber and then into the lubrication system of the engine, as well as penetration of gases from the combustion chamber into the fuel supply system when the needle in the precision guide of the body “hangs” or “freezes” in the extreme upper open position, which is known to occasionally take place during the diesels' operation. This leads to the known phenomenon of “HydroLocking”, which results in an emergency failure of the diesel engine.

Another drawback of the existing fuel systems consists in relatively low values for the lifting and (especially important) closing pressure of the sprayer unit (about 400 and 280 Bar, respectively) compared to the designed maximum injection pressures in modern diesels (2000-2500 Bar and higher). This results in the slow final stage of the injection and consequently in the delivery of poorly atomized fuel into the combustion chamber in the final phase of the injection process.

Said drawback of conventional systems is due to the fact that the effective surface of the needle which is subject to the pressure of the fuel in the beginning phase of the injection is smaller than that at the end of the injection. As a result, the lifting pressure of the needle as already mentioned is greater than the pressure of the fuel in the beginning of the seating of the nozzle needle, although in order to improve the mixture in the combustion chamber, the pressure of the fuel causing the closing of the nozzle should be higher than the lifting pressure.

Low lifting and closing pressures of the nozzle needle also decrease the average level of the injection pressure. All this leads to a decrease in the fuel efficiency and increase in the emission levels.

The hydraulically driven pump-injector in accordance with the invention is aimed at eliminating said drawbacks.

### DISCLOSURE OF INVENTION

The correlation between the electrical signal from the electronic control unit (the travel of the valve of the distributing device) and the operation of the nozzle needle aimed at elimination of the abovementioned drawbacks in controlling the injection of hydraulically driven pump-injector in accordance with the invention is improved via having the valve of the distributing device (controlled via the signal from the electronic control unit), control not only the delivery of the actuating fluid to the hydraulically driven piston of the pressure intensifier (or to the second stage of the distributing device), but at the same time its delivery to a locking piston of the needle which is mounted in the pump-injector body and directly controls the operation of the nozzle needle. Thus, via passing the second stage of the distributing device in case of a double-stage device and the hydromechanical device of the plunger drive, a direct connection between the signal from electronic control unit that controls the operation of the valve of the distributing device, and the travel of the needle of the sprayer unit is established.

Another significant drawback of conventional fuel systems, i.e. penetration of the fuel into the combustion chamber and then into the lubrication system, and the penetration of gases into the fuel system when the nozzle needle “hangs” in the extreme upper open position) is eliminated via using diesel fuel, the same as is injected into the combustion chamber, as the actuating fluid in hydraulically driven pump-injectors in accordance with the invention. At this time, the fuel (actuating fluid) is supplied to the under-plunger cavity through a central filling channel formed in the body and connecting the under-plunger cavity with above-piston space of the locking piston of the needle. Said filling channel is closed via the face of said locking piston of the needle when the needle with the locking piston is in the extreme upper open position, in which, as mentioned above, the needle usually “hangs” or “freezes”, (loses mobility). As a result, the under-plunger cavity and consequently the internal cavity of the nozzle are disconnected from the fuel supply system and thus the penetration of the fuel into the combustion chamber and penetration of gases from the combustion chamber into the fuel supply system are prevented.

The important feature of the locking device of the needle in accordance with the invention is also that it allows for controlling the level of the pressure of the actuating fluid, supplied to the locking piston of the needle in the beginning of the injection and at its end, and thus for providing a higher nozzle needle closing pressure than the lifting pressure, which, as mentioned above, is important for improving the fuel atomization in the combustion chamber and consequently the engine's characteristics.

Main design features proposed via the invention are implemented in conventional design environment which is typical of conventional hydraulically driven pump-injectors. Said design environment comprises a body with inlet and outlet channels for connection to the source of the actuating fluid (accumulator or rail, connected, in turn, to the pump of the actuating fluid), and drain tank, or sump, respectively. The pump-injector also comprises a pressure intensifier comprising at least one power piston of a diameter D, and a pumping plunger of a diameter d, disposed in the cylindrical cavities of the body. Above the power piston, a working cavity is formed, and under the power piston there is a drain cavity connected through a channel formed in the pump-injector body with a drain tank or sump. Under one of the plunger faces a high-pressure under-plunger cavity is formed, and the second face of the plunger rests upon the power piston. Said conventional design environment also comprises a distributing device with a single-stage or double-stage valve that has conical or spherical locking surfaces. The valve (or one of the valves in a double-stage configuration) has an electromagnetic drive controlled via an electronic control unit (piezoelectric, magnetostriction, mechanical or other drives can also be used). The distributing device is usually installed in the pump-injector body between said inlet and outlet channels of the body. Said design environment comprises also a return mechanism of the power piston with pumping plunger (for example, a spring mechanism) and a sprayer unit (nozzle), connected to the under-plunger cavity via a high pressure channel and comprising a nozzle body with a conical bearing surface and a needle of a diameter dₙ with a precision guide, a conical locking surface on one end of the needle having a smaller diameter of the locking edge than the diameter of the precision guide of the needle, and the second end of the needle having a bearing face.

The subject of the invention is based on the principal that in the pump-injector body above the bearing face of the needle, coaxially with the needle, an additional cylindrical cavity is made, wherein, coaxially with the needle of the sprayer unit a locking piston is mounted, the cavity and the locking piston having a diameter dₚ, which is greater than the diameter of the needle, dₙ, and the piston moving inside said additional cavity and forming a precision joint with it. In order to achieve an abrupt termination of the injection (including making the start of the termination coincide with the period of maximum injection pressures), the ratio of the cross-sections of the locking piston of the needle and of the needle must be greater than the ratio of the cross-sections of the power piston and pumping plunger, i.e. the coefficient of the pressure multiplication in the pressure intensifier. This means that the diameter of said additional cavity and, consequently, the diameter of the locking piston must be greater than the product of the diameter of the needle and the square root of the value for the coefficient of the pressure multiplication, “m” in the pressure intensifier of the pump-injector (dₚ>dₙ\sqrt{m}). Since the coefficient of the pressure multiplication, “m” equals the ratio of the squares of the diameters of the power piston (D) and plunger (d) (m=D²/d²), said correlation will take the form: dₚ>dₙ*D/d. In the proposed design, the bottom of said bearing piston of the needle rests directly or through an intermediary rod on the bearing face of the needle. In order to control the operation of the locking piston of the needle, the closed space formed above the face of the locking piston (bounded via the body) is connected periodically (synchronously with the operation of the second-stage valve and, consequently, with the operation of the hydraulically driven piston) through a distribution channel formed in the body, and the distributing device alternately to the source of the actuating fluid or to the drain tank or sump. In the pump-injector body, between the bearing face of the needle and the bottom of the locking piston of the needle, a closed drain cavity is formed, which is constantly connected via a channel formed in the body with a drain tank or sump. In said drain cavity between the needle and the locking piston of the needle, a spring is disposed, its one face resting directly or through said intermediary rod upon the bearing face of the needle, and its second face resting upon the bottom of the piston facing the needle.

Another subject of the invention is the fact that when fuel is used as the actuating fluid, a central filling channel is formed in the pump-injector body coaxially with the plunger and the locking piston of the needle, connecting the under-plunger cavity with above-piston space of said locking piston of the needle, which, as already mentioned, is connected periodically through said distribution channel and distributing device to the source of the actuating fluid (fuel). In the proposed design of the pump-injector, the under-plunger cavity can be filled via fuel, when the needle with the rod and the locking piston are in the lower (closed) position (dwell). When the needle with rod and the locking piston are in the extreme upper open position (the working stroke of the plunger, or “hanging” of the needle), the face of said locking piston closes said central filling channel. In this way, the fuel flow from the under-plunger cavity into the above-piston space of the locking piston of the needle during the working stroke of the plunger is prevented, as well as the penetration of the fuel into the combustion chamber or penetration of gas from the combustion chamber into the fuel supply system when the needle “hangs”, or “freezes” at it's upper end open position. In accordance with the invention, the return stroke of the pumping plunger with power piston can also be implemented due to the action of the fuel pressure entering the under-plunger cavity when it is being filled through said central filling channel in the period when the needle with the locking piston are in the lower (closed) position (dwell).

The invention is designed primarily for a double-stage distributing device that must be used, as mentioned before, in pump-injectors for diesels with high volume fuel delivery. From the above description it is clear that in such configuration, the first-stage valve controlled via the signal from the electronic control unit controls at the same time the operation (travel) of said locking piston of the nozzle needle, and the travel of the hydraulically driven second-stage valve (conical or spherical), and which has a hydraulic drive and controls, in its turn, the supply of the actuating fluid into the above-piston cavity of the power piston. In the open position of the second-stage valve, the actuating fluid is supplied through the valve throat and the central channel under the valve in the body into the working cavity of the power piston from the annular chamber which is formed around the valve above its locking surface and is constantly connected with the source of the actuating fluid. At this time, the power piston with the pumping plunger make their working stroke. In the closed position of the valve, said central channel is closed via the sealing between the bearing edge of the second-stage valve and the conical surface of the body, and thus the working cavity of the power piston is disconnected from the source of the actuating fluid, and the working stroke of the piston with the plunger ends.

The first-stage valve (conical or spherical) has a precision guiding part and a sealing locking part, and is disposed above the second-stage valve in the internal cavity of the pump-injector body or in its own body, mounted in the pump-injector body (hereinafter “in the body”), and forming a precision joint with the body. On the external surface of the first-stage valve, below the sealing (locking) part of the valve, a closed cylindrical annular chamber is formed, bounded via the internal surface of the cavity of the body, which is constantly connected through a channel formed in the body (a jet is mounted in the channel) with the source of the actuating fluid. The annular chamber of the valve through said distribution channel in the body is also connected with the above-piston space of said locking piston of the nozzle needle. During the working stroke of the power piston with pumping plunger, said closed annular chamber in the open position of the first-stage valve is connected with the drain cavity, formed in the body above the valve, which, in turn, is constantly connected through a channel in the body with a drain tank or sump.

Under the first-stage valve, a closed chamber is formed, which is constantly connected with said drain cavity above the valve.

In accordance with the subject of the invention, a hydraulically driven second-stage valve (conical or spherical), having a conical bearing surface and disposed in the pump-injector body under the first-stage valve or in its own body mounted in pump-injector body (hereinafter “the body”), is made as a hollow cylinder, and the internal cavity of the valve has a partition, in which bores are made that connect the internal cavity of the valve through said central channel with the above-piston working cavity of the power piston. The valve has a precision guiding part connected with the body, and, as mentioned above, a conical (or spherical) locking part, the diameter of the circumference of the locking edge of the valve being smaller than the diameter of the guiding precision part. Therefore, in the closed position, the force applied to the second-stage valve equals the product of the pressure of the actuating fluid and the annular area bounded via the circle that correspond to the outer-diameter of the valve and the circle of the bearing edge of the sealing surface of the valve.

In accordance with the invention, in the part of the body of the first-stage valve that faces the second-stage valve, cylindrical bores are made, in which coaxially with the valves of the first and the second stages one after another, in a tandem, two mobile rods of different diameters are installed, which have precision joints with the bores. Said rods' faces contact each other, accomplishing the return stroke of the second-stage valve and accordingly pressing the valve to the bearing conical surface of the body. The working stroke of the second-stage valve (its travel from the extreme lower into extreme upper position) is accomplished due to the pressure of the actuating fluid contained in said annular chamber which is disposed above the bearing surface of the second-stage valve, acting, as mentioned above, upon the annular area bounded via the outer and bearing diameters of the valve. During its movement, the second-stage valve overcomes the force of said rods. In order to control said rods, a cavity is made near one of the faces of the larger-diameter rod in the body, said cavity being constantly connected via a channel with said annular chamber of the first-stage valve. During the working stroke of the second-stage valve, in the open position of the first-stage valve, the pressure in said cavity falls, and the rod ceases to interfere with the upward travel of the second-stage valve. Near the contacting faces of the larger- and smaller diameter rods, a cavity is formed, which is constantly connected through a channel formed in the body with said drain cavity made above the valve. The second face of the smaller-diameter rod rests upon said partition of the second-stage valve and transfers the force from the larger-diameter rod to the second-stage valve. The smaller-diameter rod can also be connected with the second-stage valve via a nut that has a fork-type or other swivel connection with the valve. In this case, after the second-stage valve opens, the force moving the second-stage valve during its working stroke increases. This is due to the fact that the pressure of the actuating fluid supplied into the internal cavity of the valve from the above-piston cavity of the power piston through said bores in the partition of the second-stage valve and central channel of the body in the open position of the second-stage valve acts upon the face of the smaller-diameter rod.

In order to decrease the dimensions (length) of the proposed distributing device, said partition of the second-stage valve is made in its lower part above the locking surface of the valve, and the section of the body of the first-stage valve, in which said rods are disposed, is disposed inside the cavity of the second-stage valve.

To remove the exhausted actuating fluid from the above-piston cavity of the power piston during the return stroke of the piston, in the body, at the upper face of the second-stage valve, an annular groove is made which is constantly connected through a channel formed in the body with said drain cavity above the first stage valve. The annular groove in the body is disposed in such a way that in the lower closed position of the second-stage valve, the internal cavity of the valve is connected with said groove of the body. The actuating fluid from the above-piston cavity of the power piston through said central channel in the body, the bore in the partition of the second-stage valve, the internal cavity of the second-stage valve and then through said annular groove in the body and said outlet channel formed in the body, is expulsed during the return stroke of the piston into the drain tank. In the open position of the second-stage valve, the upper face of the valve closes said annular groove in the body and disconnects the internal cavity of the valve, and consequently, the above-piston cavity of the power piston, from said annular groove of the body and consequently from the drain tank.

Therefore, in accordance with the above description of the main features of the invention, the distributing device operates as follows. Between the working strokes, the second-stage valve is in closed extreme lower position (the dwell position) due to the action of the larger-diameter rod, the working cavity above said rod being connected with the source of the actuating fluid in the closed position of the first-stage valve. At the same time, the actuating fluid through the distributing channel in the body is supplied from the chamber of the piston of the first stage into the above-piston cavity of the locking piston of the needle, which presses the needle to the bearing surface of the nozzle body due to the action of the actuating fluid. When the first-stage valve opens, the pressure in the above-piston space of the locking piston of the needle and inside the cavity of the larger-diameter rod decreases. As a result, due to the action of the fuel pressure pumped via the plunger, the nozzle needle overcomes the force of the locking piston, and lifts. At the same time, the second-stage valve begins its travel upward (i.e., begins to open) due to the action of the pressure of the actuating fluid acting on the annular surface bounded via the outer and bearing diameters of the second-stage valve, and the injection of the fuel begins. When the first-stage valve closes, the pressure in the above-piston space of the locking piston of the needle and inside the cavity above the larger-diameter rod increases, and the nozzle needle is seated on the seat of the body nozzle due to the pressure of the actuating fluid, and the larger-diameter rod moves the second-stage valve into the initial closed position.

In accordance with the subject of the invention, stepwise injection (“rate shaping”) can be achieved. A detailed description of the design features of the pump-injector elements ensuring the required injection characteristics is given below in the sections “Summary of the invention” and “Best mode for carrying out of the invention”.

The main features of the proposed hydraulically driven pump-injector described above allow for a significant improvement of the injection characteristics, and accordingly main engine parameters relating to the fuel efficiency, reliability and noise level, as well as emission levels.

### SUMMARY OF THE INVENTION

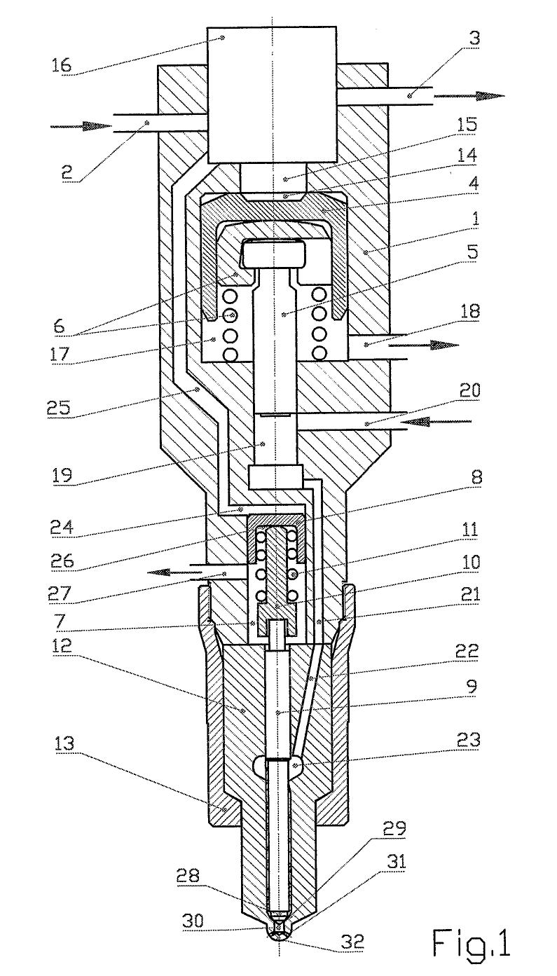

FIG. 1 shows a functional diagram of a hydraulically driven pump-injector with a locking piston controlling the needle of the sprayer unit.

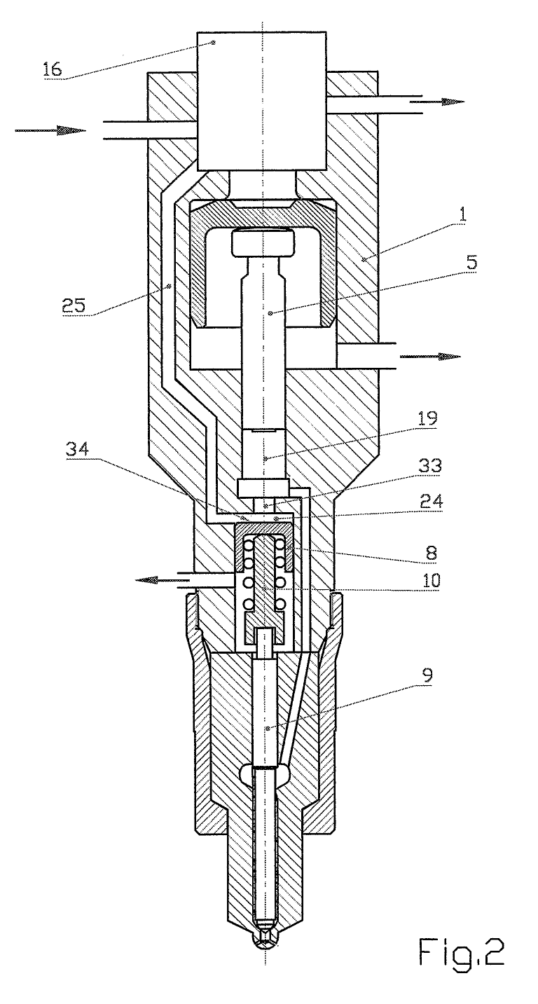

FIG. 2 shows a functional diagram of a hydraulically driven pump-injector in which fuel is used as actuating fluid, and in which the locking piston of the needle shown in FIG. 1 controls the filling of the under-plunger cavity with fuel.

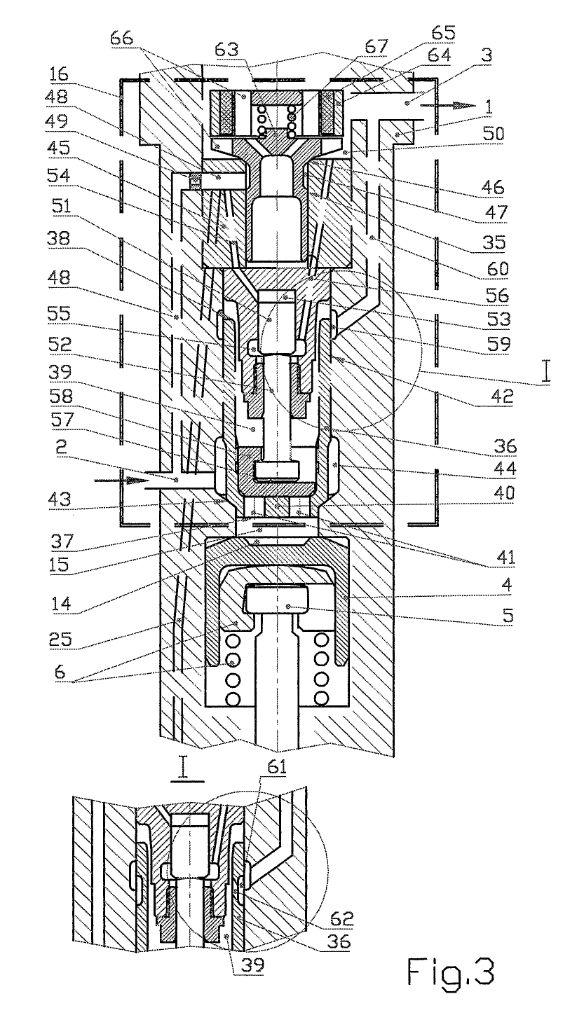

FIG. 3 shows a functional diagram of the distributing device of hydraulically driven pump-injector.

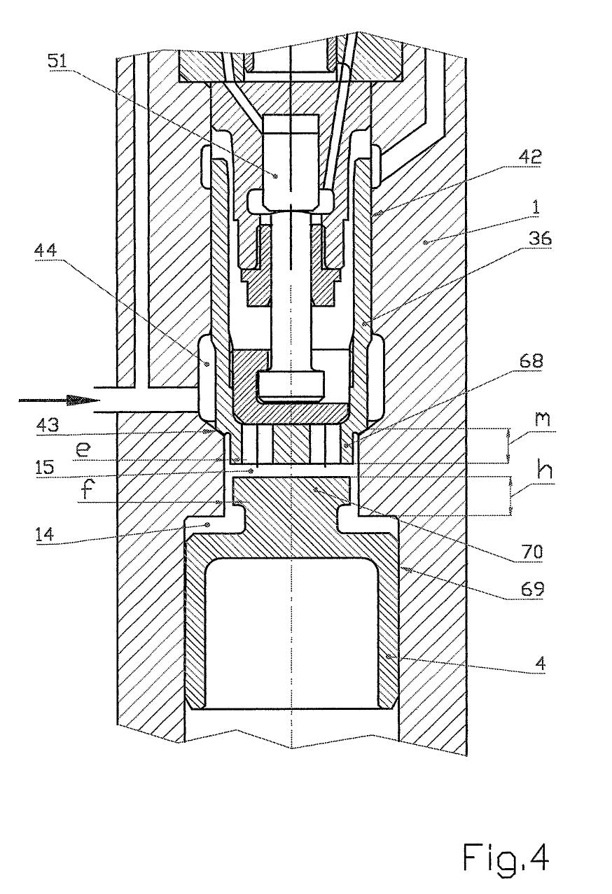

FIG. 4 shows a detailed functional diagram of the second-stage valve of the distributing device and of the power piston allowing for achieving “rate shaping”.

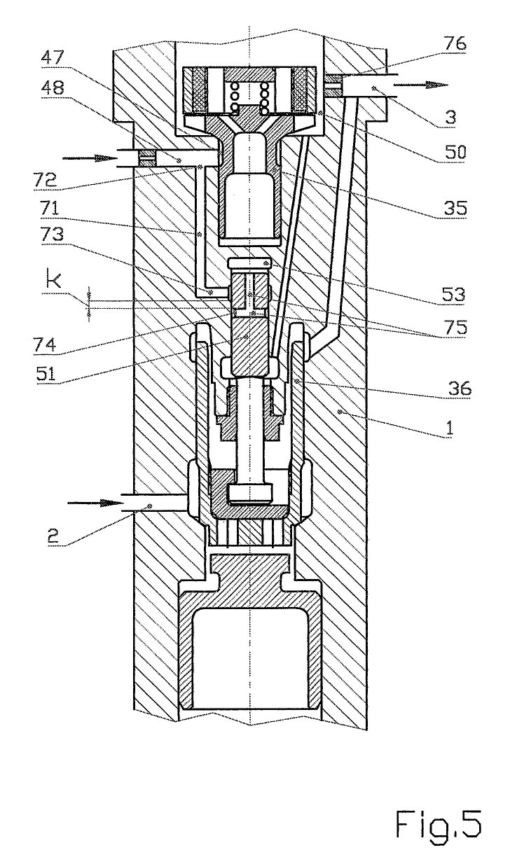

FIG. 5 shows a detailed functional diagram of a larger-diameter rod of the hydraulically driven second-stage valve allowing for achieving stepwise injection (“rate shaping”).

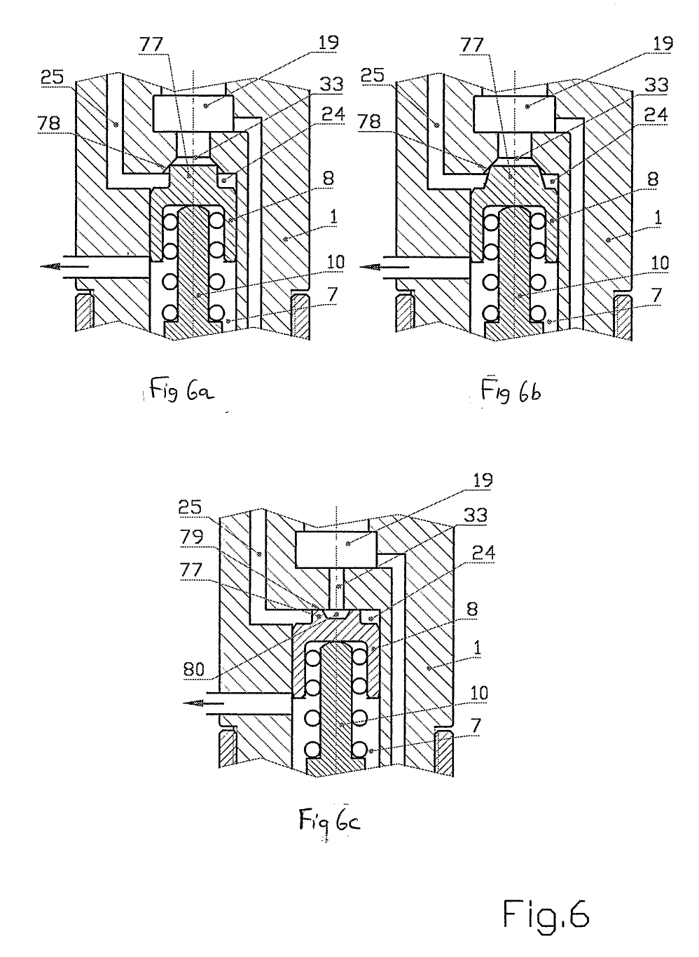

FIG. 6 shows detailed functional diagrams of locking devices of the locking piston of the nozzle needle (a—with a conical protrusion, b—with a spherical protrusion, c—with flat or cylindrical protrusion and a bore inside the protrusion).

In FIG. 1:

1—pump-injector body; 2—inlet channel connecting the pump-injector body to the source of the actuating fluid (accumulator); 3—outlet channel connecting the pump-injector to the drain tank; 4—power piston; 5—pumping plunger; 6—return mechanism; 7—cavity in the pump-injector body; 8—locking piston of the nozzle needle; 9—nozzle needle; 10—rod; 11—return spring of the nozzle needle; 12—nozzle body; 13—nut connecting the pump-injector body with the nozzle body; 14—working cavity of the power piston; 15—central channel in the pump-injector body; 16—distributing device; 17—drain cavity under the power piston; 18—channel in the pump-injector body connecting drain cavity 17 to the drain tank; 19—under-plunger cavity; 20—lateral filling channel in the pump-injector body connecting the under-plunger cavity with the diesel fuel system; 21—high-pressure channel in the pump-injector body connecting under-plunger cavity 19 with the nozzle; 22—channel in the nozzle body; 23—chamber in the nozzle body; 24—above-piston space of the locking piston 8; 25—channel connecting distributing device 16 with above-piston space 24 of piston 8; 26—bottom of piston 8; 27—channel in the pump-injector body connecting cavity 7 under piston 8 to the drain tank; 28—locking cone of the nozzle needle; 29—seat in the nozzle body; 30—channel in the nozzle body under needle 9; 31—spraying orifice; 32—nozzle nose.

In FIG. 2:

33—central filling channel in the pump-injector body connecting under-plunger cavity 19 with above-piston space 24 of piston 8; 34—face of piston 8;

In FIG. 3:

35—first-stage valve of the distributing device; 36—second-stage valve of the distributing device; 37—lower face of the second-stage valve; 38—upper face of the second-stage valve; 39—internal cavity of the second stage; 40—partition in the lower part of the second-stage valve; 41—bores in partition 40 of the second-stage valve; 42—precision guiding part of the second-stage valve; 43—locking part of the second-stage valve; 44—annular chamber in the pump-injector body near the locking part of second-stage valve 36; 45—body of the first-stage valve; 46—sealing surface of the first-stage valve; 47—cylindrical chamber of the first-stage valve; 48—channel in the body connecting chamber 47 with the source of the actuating fluid; 49—jet in channel 48; 50—drain cavity in the body; 51—rod of a larger diameter; 52—rod of a smaller diameter; 53—cavity near the upper face of larger-diameter rod 51, connected through channel 48 with chamber 47; 54—channel connecting cavity 53 with channel 48 and then with chamber 47; 55—cavity near the contacting faces of rods 51 and 52; 56—channel, connecting chamber 55 with drain cavity 50; 57 face of rod 52; 58—nut attaching rod 52 to second-stage valve 36; 59—annular chamber in pump-injector body; 60—channel, connecting chamber 59 with outlet channel 3; 61—annular chamber on the precision surface of the second-stage valve; 62—channel in the second-stage valve, connecting chamber 61 with internal cavity 39 of valve 36; 63—disk-like extension of the first-stage valve 35 (the armature of the electromagnet); 64—body of the electromagnet; 65—winding of the electromagnet; 66—radial slots in armature 63 and body 64 of the electromagnet; 67—return spring of the electromagnet.

In FIG. 4:

68—protrusion on second-stage valve 36; 69—bore in the pump-injector body where power piston 4 is moving; 70—cylindrical (conical) protrusion on power piston 4.

In FIG. 5:

71—channel, connecting cavity 53 with channel 48; 72—end of channel 71, connected through annular gap between the upper part of rod 51 and body 1 with channel 48; 73—end of channel 71, superposed with groove 74; 74—annular groove on rod 51; 75—channels in rod 51, connecting cavity 53 with groove 74; 76—jet, through which drain cavity 50 is connected with outlet channel 3.

In FIG. 6:

77—protrusion on locking piston 8; 78—conical surface in the pump-injector body; 79—face in pump-injector body 1; 80—cylindrical or conical bore in protrusion 77.

Hydraulically driven pump-injector shown in FIG. 1 comprises body 1 with inlet 2 and outlet 3 channels. In body 1, a pressure intensifier is disposed, comprising power piston 4, pumping plunger 5 and spring return mechanism 6. Coaxially with pumping plunger 5, locking piston 8 of needle 9 is disposed in cylindrical cavity 7 of body 1, said piston also disposed coaxially with said needle and transferring the force to the face of the needle through rod 10, disposed in said cavity 7; between rod 10 and needle 9, return spring 11 of the needle of the sprayer unit is installed. Needle 9 is moving in body 12 of the sprayer unit, which is attached to body 1 of the pump-injector via nut 13. Above power piston 4, working cavity 14 is made, which is periodically connected through central channel 15, distributing device 16 disposed in body 1 of the pump-injector, and said channels 2 and 3 to the source of the actuating fluid (accumulator, rail) and drain tank or sump, respectively. In the distributing device, a valve is used as a control element, predominantly having an electromagnetic drive controlled via an electronic control unit (piezoelectric, magnetostriction, mechanical or other drives can also be used). Under power piston 4 drain cavity 17 is made which is constantly connected through channel 18 in pump-injector body to the drain tank. Under pumping plunger 5, a high-pressure under-plunger cavity 19 is made; this cavity is filled with fuel from the engine's supply system through channel 20 when the plunger is in extreme upper position, and during the plunger working stroke, after channel 20 is closed, this cavity pumps the fuel through high-pressure channel 21 in body 1 of the pump-injector and channel 22 in body 12 of the sprayer unit into chamber 23 of body 12 of the sprayer unit. Above-piston space 24 of locking piston 8 is connected through distribution channel 25 with distributing device 16, and cavity 7 under bottom 26 of piston 8 is constantly connected through channel 27 to the drain tank. The hydraulically driven pump-injector described above operates as follows:

Between the working strokes of pumping plunger 5 (in dwell position) when the electrically controlled valve of the distributing device is de-energized, above-piston cavity 14 of power piston 4 is disconnected through distributing device 16 from the source of the actuating fluid. Due to the action of the pressure of the actuating fluid, locking piston 8 with rod 10 and needle 9 moves into extreme lower position, and locking cone 28 of needle 9 is seated on seat 29 in body 12 of the sprayer unit, closing the passage of the fuel to channel 30 under the needle and then to spraying orifices 31 of nozzle nose 32. When the electromagnet or piezo actuator of the valve of the distributing device 16 is energized, above-piston cavity 14 of power piston 4 disconnects from the drain tank and connects to the source of the actuating fluid. At the same time, above-piston space 24 of locking piston 8 through channel 25 disconnects from the source of the actuating fluid and is connected to the drain tank, while power piston 4 with pumping plunger 5 makes its working stroke and expulses the fuel through channels 21 and 22 into chamber 23 of the sprayer unit body, and needle 9, released from the pressure of locking piston 8, having to overcome only the force of spring 11, is lifted into extreme upper position due to the pressure of the fuel on the differential cross section of needle 9, and opens the passage of the fuel to spraying orifices 31, so that the injection of the fuel into the combustion chamber begins. When the electromagnet or piezo actuator of the valve of the distributing device 16 is de-energized, above-piston cavity 14 of power piston 4 is again connected to the drain tank, and the actuating fluid is supplied into above-piston space 24 of locking piston 8. Due to the pressure of the actuating fluid, piston 8 through rod 10 quickly closes needle 9 of the sprayer unit even before the pressure of the actuating fluid above power piston 4 decreases. The injection stops, and the pressures in the final phase of the injection decreases sharply. As already mentioned, this sharp decrease results in greater fuel efficiency and lower exhaust smoke emission, in particular PM. In hydraulically driven pump-injector described above, the volume of fuel delivery is controlled by the duration of the signal fed from the electronic control unit to the electromagnet or piezo actuator of the valve of the distributing device. Hydraulically driven pump-injector shown in FIG. 2 operates similarly to the one shown in FIG. 1. The main difference consists in that, in hydraulically driven pump-injector shown in FIG. 2, fuel is used as the actuating fluid; therefore, there is no lateral filling channel 20 shown in FIG. 1, and under-plunger cavity 19 is filled through central filling channel 33 formed in body 1 and connecting under-plunger cavity 19 with above-piston space 24 of locking piston 8. Under-plunger cavity 19 is filled through filling channel 33 in the dwell position, when piston 8 with rod 10 and needle 9 are in the extreme lower closed position, and above-piston space 24 through channel 25 and distributing device 16 is connected with the source of the actuating fluid. During the working stroke of pumping plunger 5, locking piston 8 with needle 9 is in the extreme upper (open) position, and face 34 of piston 8 closes said central filling channel 33. Channel 33 is closed via face 34 of piston 8 also when the needle “hangs” (stops in the extreme upper position). This fact, as has already been mentioned, prevents the penetration (or leakage), of the fuel into the combustion chamber from the engine's fuel supply system, and prevents the penetration of gases from the combustion chamber into the engine's fuel supply system.

Distributing device 16 (FIG. 3) is two-stage and consists of the first stage—electromagnetically controlled valve 35 (the valve, as previously mentioned, can also be driven via other types of drives), which controls at the same time the operation (movement) of said locking piston 8 (FIGS. 1 and 2) of the nozzle needle and the movement of second-stage valve 36 which has a hydraulic drive and controls, in its turn, the operation of power piston 4, connecting periodically working cavity 14 of power piston 4 through central channel 15 in body 1 during the injection to the source of the actuating fluid, and between the injections—to the drain cavity.

Hydraulically driven second-stage valve 36, disposed in pump-injector body 1 (valve 36 can also be disposed in a separate body mounted in the pump-injector body), is made as a hollow cylinder with lower 37 and upper 38 faces and internal cavity 39 which has in its lower part partition 40, wherein bores 41 are made that connect internal cavity 39 of valve 36 with the above-piston cavity 14 of power piston 4; the valve has a precision guiding part 42 and conical or spherical locking part 43, the diameter of the circular locking edge of said conical or spherical part 43 being smaller than the diameter of guiding precision part 42, while near the locking edge in the pump-injector body, annular chamber 44 is made which is constantly connected through channel 2 with accumulator of the actuating fluid, said chamber 44 being disposed in such a way that when said second-stage valve 36 opens, the actuating fluid is supplied through central channel 15 into above-piston cavity 14 of power piston 4 formed in the pump-injector body.

Valve 35 of the first stage can be disposed in the pump-injector body or in its own body 45, mounted in the pump-injector body (hereinafter “the body”); it has a conical or spherical locking surface 46, and below said surface closed cylindrical chamber 47 is made, bounded via the internal surface cavity of body 45, which is constantly connected through a channel formed in body 48 and jet 49 mounted in the channel with the accumulator of the actuating fluid. Said chamber 47 through distribution channel 25 (FIGS. 1, 2, 3) in body 1 is constantly connected with above-piston space 24 of said locking piston 8 (FIGS. 1, 2) that controls the operation of the nozzle needle. During the injection, said closed annular chamber 47 in the open position of first-stage valve 35 is connected with drain cavity 50, connected through channel 3 to the drain tank. In body 45, cylindrical bores are made, in which coaxially with hydraulically controlled valve 36, two rods 51 and 52 having different diameters are installed one after another in a tandem, their faces contacting each other; near one of the faces of larger-diameter rod 51, cavity 53 is made in the body, which is constantly connected via channel 54 with said chamber 53 of first-stage valve 35, while near the second face of larger-diameter rod 51, cavity 55 is made, which adjoins one of the faces of smaller-diameter rod 52, while said cavity 55 is constantly connected via channel 56 disposed in body 45 with drain cavity 50; the second face 57 of smaller-diameter rod 52 rests upon said partition 40 of second-stage valve 36. In another suitable design, rod 52 is connected via nut 58 and fork-type or another swivel joint with second-stage valve 36, face 57 of smaller-diameter rod 52 being subject to the pressure of the actuating fluid introduced into internal cavity 39 of valve 36 from above-piston cavity 14 of power piston 4 through said bores 41 in partition 40 of second-stage valve 36 when the valve opens. This results in the increase in the force that moves the second-stage valve during its working stroke (i.e., its travel from the lower closed position to the upper open position).

In accordance with the invention, said partition 40 of second-stage valve 36 is made in the lower part near locking surface 43 of said valve 36, while the part of body 45 of first-stage valve 35, in which said rod and 51 and 52 are located, is disposed inside the cavity of second-stage valve 36. This arrangement allows for reducing the dimensions (length) of distributing device 16.

In body 1 of the pump-injector, near upper face 38 of hydraulic second-stage valve 36, annular groove 59 is made, which is constantly connected via channel 60, formed in body 1 of the pump-injector, with drain cavity 50, said annular groove 59 being disposed in such a way that when second-stage valve 36 is in the closed position, the actuating fluid from above-piston cavity 14 of power piston 4 is expulsed via return mechanism 6 of piston 4 during the return stroke of the piston through said central channel 15 in the body and bores 41 in partition 40 of second-stage valve 36 into internal cavity 39 of said second-stage valve and then through said annular groove 59 and channel 60 made in the pump-injector body into drain cavity 50, and then through channel 3 into the drain tank. In the open position of second-stage valve 36, upper face 38 of valve 36 closes said annular groove 59 in the body and disconnects internal cavity 39 in the valve, and, consequently, also above-piston cavity 14 of power piston 4 from said annular groove 59 and consequently, from the drain tank. In another embodiment (FIG. 3-I), on the external surface of second-stage valve 36, groove 61 is made, which is constantly connected through bores 62 with internal cavity 39 of the valve and through which the internal cavity in said valve in its closed (extreme lower) position is connected to said annular groove 59 of the body, connected with drain cavity 50 through channel 60. First-stage valve 35, after locking surface 46, has an extension in the form of disk 63, which is perpendicular to the axis of the valve, and serves as armature of the electromagnetic drive of the valve which is attracted to the body of electromagnet 64 when winding 65 of the electromagnetic drive is energized. Disk 63 and body 64 have radial slots 66.

The distributing device in accordance with the invention (FIG. 3) operates as follows: between the injections (when the electromagnet is de-energized), chamber 47 is subject to the pressure of the actuating fluid. Therefore, chamber 53 of rod 51 and above-piston space 24 of locking piston 8 (FIGS. 1 and 2) are also subject to said pressure, and are connected with chamber 47 via channels 54 and 25, respectively. Due to the action of the actuating fluid rod 51 through rod 52 acts upon second-stage valve 36, which travels down and stops the flow of the actuating fluid from groove 44 into central channel 15 and then into above-piston space 14. At the same time piston 8 (FIGS. 1, 2), that causes the needle to seal the nozzle, moves into extreme lower position. When electromagnet 64 is energized, disk 63 of valve 35 (armature of the electromagnet) is attracted to the body of electromagnet 64, valve 35 opens, and the actuating fluid through jet 49 and throat of valve 35 formed between body 45 and locking surface 46 of valve 35 flows into drain cavity 50. Due to the throttling of the actuating fluid in jet 49, the pressure in working chamber 47 falls, and consequently, the pressure inside cavity 53 of rod 51 and in above-piston space 24 of locking piston 8 falls, too (FIGS. 1, 2). This results in second-stage valve 36 due to the action of the actuating fluid on the annular surface (equal to the difference of areas corresponding to the diameter of precision surface 42 and bearing edge of valve 43) overcoming the force of rod 51 traveling upward and opening the passage of the actuating fluid from annular groove 44 to channel 15 and then to piston 4. After valve 36 has started to travel up, the actuating fluid through bore 41 in partition 40 of valve 36 flows into internal cavity 39 of valve 36 and acts upon face of rod 52, creating in the presence of nut 57 an additional effort required for lifting valve 36. At the same time, when the actuating fluid flows into piston 4 and the working stroke of piston with plunger 5 begins, needle 9 with piston 8, due to the action of the fuel on the differential cross section of the needle (annular surface bounded via the outer surface or bearing circle), travel upward, and the injection of fuel into the combustion chamber begins. When winding 64 of the electromagnet is de-energized, valve 35 closes due to the action of spring 67, the pressure in chamber 47, and consequently in cavities 53 and 24, increases. Due to the action of rod 51 of valve 36, and at the same time, due to the pressure of the actuating fluid acting on piston 8 the nozzle needle descends, the flow of the actuating fluid to piston 4 stops, and the injection of the fuel into the combustion chamber stops abruptly.

In hydraulically driven pump-injector in accordance with the invention, stepwise injection (“rate shaping”) can be achieved via limiting the flow of the actuating fluid into above-piston space 14 of power piston 4 in the beginning phase of the working stroke of the power piston. In this case, “rate shaping” can be achieved via changing the design of three components of the pump-injector: second-stage valve 36, power piston 4 (FIGS. 4 and 5), and larger-diameter rod 51.

The proposed designs of said components given below can be used all together or separately.

To achieve “rate shaping” using valve 36 (FIG. 4), central channel 15 in body 1 which in the open position of valve 36 connects annular groove 44 near locking edge 43 of hydraulically driven second-stage valve 36 with above-piston cavity 14 of power piston 4, is made coaxial with bore 42 in the body, where the second-stage valve is moving, and on the valve, after sealing surface 43, on the face of the valve facing said central channel 15 of body 1, cylindrical or conical protrusion 68 is made coaxially with precision guide 42 of the hydraulic second-stage valve (FIG. 4), that runs into said central channel 15 of body 1.

To achieve “rate shaping” using power piston 4, said central channel 15 of body 1 is also made coaxial with bore 69 in the pump-injector body, where power piston 4 is moving, and on the face of power piston 4, facing said central channel, cylindrical or conical protrusion 70 is made, which runs into said central channel 15 of body 1. The presence of said protrusions decreases the volume flow rate of the actuating fluid to the power piston (until they leave channel 15) and thus limit the speed of the power piston in the beginning phase of its working stroke. Via changing the height of said protrusions 68 and 70, and also the size of the gaps “e” and “f” (FIG. 4), connecting the protrusions with said channel 15, one can control the duration and rate of the beginning phase during stepwise injection depending on the parameters of a particular engine under consideration.

To achieve “rate shaping” using larger-diameter rod 51 (FIG. 5), cavity 53 above upper face of said rod 51 is connected with said chamber 47 of electrically controlled first-stage valve 35 via means of connecting channel 71 formed in the body, whose end 72 is connected constantly with said chamber 47 of first-stage valve 35, and the second end 73 is connected to annular groove 74, formed on the cylindrical surface of said larger-diameter rod 51 and connected via channels 75 with said cavity 53 above larger-diameter rod 51, said groove 74 on the rod being disposed with respect to said end 73 of said channel 71 in such a way that the connection between said groove 74 with said end 73 of channel 71 begins after a certain predetermined travel <<k>> of said larger-diameter rod 51 from the extreme lower position in which it remains when second-stage valve 36 is in the lower closed position, the gap between cylindrical surface of rod 51 and body in the area of said annular groove 74 on larger-diameter rod 51 being larger than the gap disposed in the area below said annular groove 74 in the precision joint of larger-diameter rod and the body.

Via changing the “k” value of rod 51 from the extreme lower position till the value corresponding to the connection of groove 74 with end 73 of channel 71, and also changing the value of the gap near the upper section of the rod (above the groove), one can control the duration and intensity of the first low-intensity phase of step-wise injection (FIG. 6). As an additional means of speeding up the closing of first-stage valve 35 in accordance with the invention, the pressure in drain cavity 50 is increased via installing jet 76 at the outlet of the actuating fluid from said cavity 50 into outlet channel 3 (FIG. 5). This improves the controllability of the last phase of the injection.

### BEST MODE FOR CARRYING OUT OF THE INVENTION

In accordance with the diagrams shown in FIGS. 1, 2 and 3, first-stage valve 35 is disposed in its own body 45, which in turn is installed in body 1 of the pump-injector, while second-stage valve 36 is mounted directly in body 1 of the pump-injector forming a precision joint with it. Such a design allows for simplifying the delivery of the actuating fluid from inlet channel 2 to above-piston cavity 14 of piston 4 and solving the problem of sealing of the actuating fluid in the pump-injector. However, in alternative embodiments of the pump-injector, both first-stage and second-stage valves of the distributing device are disposed directly in the pump-injector body, or in a separate body mounted in the body of the pump-injector. The required pump-injector design must be selected depending on the requirements for the pump-injector dimensions and its arrangement in the cylinder of a specific engine.

In accordance with the invention, first-stage valve 35 whose expanded part (disk 63) serves as armature of the electromagnetic drive, should best be produced of low-carbon steel in order to increase magnetic permeability with subsequent nitriding to increase durability of the cylindrical guide and sealing surfaces of the valve.

In accordance with the invention, in the upper part of valve 63 serving as armature, and in body 64 of the electromagnetic drive, radial slots 66 are made (FIG. 3) in order to decrease the effect of whirling currents generated in the valve and in the body on the operating speed of the electromagnetic drive and thus improve the valve controllability.

In accordance with one of the subjects of the invention, to enable more accurate and reliable operation of locking piston 8 of the nozzle needle (FIG. 6), protrusion 77 is made on the face of said locking piston 8 of the nozzle needle, the cross-sectional area of said protrusion being smaller than the cross-sectional area of the locking piston, and the face of said protrusion locking said central filling channel 33 connecting the under-plunger cavity with said above-piston space 24 when piston 8 with needle 9 are in the extreme upper (open) position.

Said protrusion 77 may have a cylindrical (a), conical or spherical (b) form, and it rests upon conical surface 78 of the bore which is disposed coaxially with under-plunger cavity 19 of body 1, and into which said central filling channel 33 runs, which connects the under-plunger cavity with space 24 above locking piston 8, said locking elements (protrusion 77 and conical surface 78 of said bore in the body) contacting each other along a circular base line or a conical surface. To enable normal operation of the pump-injector in accordance with the invention (i.e. to enable the opening of the nozzle in the beginning of the working stroke of the plunger), the area of the circle of a diameter equal to said base line, or inner diameter of the bearing surface of the resulting locking device should be smaller than the area of the differential cross-section of the nozzle needle (the difference in the areas of the cross-section of the precision guide and area corresponding to the locking circumference of the bearing edge of the cone of the nozzle needle), and the difference in the areas of the cross-section (required to ensure the closing of the nozzle in the final phase of the injection) of locking piston 8 and the circle corresponding to the bearing contour of the protrusion or inside diameter of the bearing cone, divided via pressure multiplication coefficient in the pressure intensifier (ratio of the cross-section areas of power piston 4 and pumping plunger 5, FIG. 1) must be greater than the cross-sectional area of the precision guide of the nozzle needle.

In accordance with the invention, protrusion 77 may have flat face 79 (FIG. 6c). In this case, the face of body 1, in which said central filling channel 15 runs, is flat, and on the face of protrusion 77 of locking piston 8, having a cylindrical or conical form and adjoining said face 79 of body 1, cylindrical bore 80 is made coaxial with protrusion 77, whose inside diameter is smaller than the outer diameter of the protrusion and in which said central filling channel 33 runs when piston 8 is in the extreme upper position. To enable normal operation of the pump-injector in accordance with the invention (i.e. to enable the opening of the nozzle in the beginning of the working stroke of the plunger), the area of the circle corresponding to the inside diameter of said cylindrical bore 80 of protrusion 77 should be smaller than the area of the differential cross-section of the needle (as defined above), and to enable the closing of the nozzle in the final phase of the injection, the difference in the areas of the cross-section of piston 8 and area corresponding to the outer diameter of the protrusion, divided via pressure multiplication coefficient (as defined above) in the pressure intensifier, must be greater than the cross-sectional area of the precision guide of the nozzle needle.

In all variants of the design of protrusion 77 described above, the diameter of central filling channel 33 connecting the under-plunger cavity with above-piston space 24 of locking face 8 of the nozzle needle should be smaller than the bearing diameter of protrusion 77 (variants “a” and “b”), or inside diameter of the cylindrical bore of the protrusion (variant c).

It will be evident to those skilled in the art that the invention is not limited to the details of the foregoing illustrated embodiments in part of summary and mode of invention and that the present invention may be embodied in other specific forms without departing from the spirit or essential attributes thereof. The present embodiments are therefore to be considered in all respect as illustrative and not restrictive, the scope of the invention being indicated via the appended claims rather than via the foregoing description, and all changes which come within the meaning and range of equivalency of the claims are therefore intended to be embraced therein.

### INDUSTRIAL APPLICABILITY

Hydraulically driven pump-injector in accordance with the invention can be used in all types of diesel engines. Locking device of the nozzle needle can be used both in combination with a single-stage distributing mechanism normally used in diesels of small cylinder capacity, and with double-stage distributing mechanism of the actuating fluid (for instance, with the one described above and constituting one of the subjects of this invention), which is best used in hydraulically driven pump-injectors of large cylinder diesels used in heavy off roads, locomotives, marine applications and power generators. In these applications, the advantages of the proposed hydraulically driven pump-injector with regard to operational speed, response, improvement of controllability of the injection, and in particular to abrupt termination of the final phase of the injection and obtaining multiphase injection (aimed at achieving greater fuel efficiency and durability, and lower exhaust smoke emission, in particular PM) can be best realized.

1. Hydraulically driven pump-injector (pump-injector) with controlling mechanism for internal combustion engines, primarily for diesels, comprising the following standard components:
a body with inlet and outlet channels for the connection to the source of the actuating fluid (accumulator, rail, which is in turn connected to the pump of the actuating fluid), and drain tank or sump, respectively;
pressure intensifier disposed in internal cavities of the body and comprising at least one power piston (of a diameter D) and pumping plunger (of a diameter d), a working cavity being formed in the pump-injector body above the power piston to which the actuating fluid is supplied from accumulator (rail), and a drain cavity being formed under the piston, connected to the drain tank or sump, a high-pressure under-plunger cavity being formed under one of the faces of the pumping plunger in the pump-injector body, which is connected, when the plunger is in extreme upper position (dwell position) through a lateral filling channel, formed in the body, with the diesel's fuel supply system, the second face of the plunger being set against the power piston;
a distributing device mounted in the pump-injector body, which can be single-stage (comprising a single valve with conical or spherical locking surface directly controlling the supply of the actuating fluid into the working cavity of the power piston) or double-stage (comprising a first-stage valve with conical or spherical locking surface controlling the operation of the second-stage valve which also has a conical or spherical sealing surface and controls the supply of the actuating fluid into the working cavity of the power piston), the valve of a single-stage distributing device or the first-stage valve of a double-stage distributing device have an electromagnetic (with a return spring) drive controlled by an electronic control unit (piezoelectric, magnetostriction, mechanical or other drives can also be used);
a spring return mechanism of the power piston with pumping plunger;
a sprayer unit (nozzle) attached to the pump-injector body by a nut and connected to the under-plunger cavity by a high pressure channel, comprising a body with a conical locking surface and a precision-guide needle (of a diameter dₙ) with a precision cylindrical guide and conical locking surface on one end of the needle, whose locking edge's diameter is smaller than the diameter of the precision guide of the needle, and a bearing face on the other end of the needle, and also comprising a return spring of the needle;
said pump-injector being distinguished by the fact that in the pump-injector body above the needle (coaxially with the needle), an additional cylindrical cavity is made, in which, coaxially with the needle, a locking piston of the needle is mounted, which is capable of moving in said cavity and has a precision joint with it, the diameter of said additional cavity, and consequently the diameter of said locking piston, dₚ having to be necessarily greater than the diameter of the needle, dₙ, or, more accurately, the diameter of the piston, dₚ having to be greater than the product of the diameter of the needle, dₙ and the ratio of the diameter D of the power piston to the diameter d of the pumping plunger (dₚ>dₙ×D/d), the bottom of said locking piston resting directly or through an intermediary rod on said bearing face of the needle, while a closed space formed above the face of the locking piston of the needle through a distribution channel, formed in the pump-injector body, and through said single-stage distributing device (or through the first-stage valve of a double-stage distributing device) is periodically connected, synchronously with the work of the power piston to the source of the actuating fluid and with drain tank or sump, alternately.

2. Hydraulically driven pump-injector according to claim 1, wherein in said additional cavity of the pump-injector body between the bearing face of the needle and the bottom of the locking piston of the needle, a closed drain cavity is formed, which is constantly connected through a channel made in the pump-injector body with drain tank or sump.

3. Hydraulically driven pump-injector according to claim 2, wherein said return spring of the needle is disposed in the drain cavity between the needle and the needle's locking piston, its one face resting directly or through an intermediary rod upon the bearing face of the needle, and its second face resting upon the bottom of the piston facing the needle.

4. Hydraulically driven pump-injector according to claim 3, wherein fuel is used as the actuating fluid, and instead of said lateral filling channel of the under-plunger cavity, a central filling channel is made coaxially with the plunger under the plunger in the pump-injector body connecting the under-plunger cavity with the above-piston space of said locking piston of the needle in the lower (locked) position of the needle with the locking piston (dwell position), said space being connected, as mentioned earlier, to the source of the actuating fluid (fuel) in the dwell position.

5. Hydraulically driven pump-injector according to claim 3, wherein the first-stage valve of the distributing device that has a precision guiding part and sealing (conical or spherical) part, is disposed above the second-stage valve inside the cavity of the pump-injector body (which is coaxial with the second-stage valve) or inside the cavity of its own body, mounted in the pump-injector body (hereinafter “in the body”), and forming a precision joint with it, a drain chamber being made under the precision part of the valve which is constantly connected with the drain cavity formed above the sealing part of the valve, which in turn is constantly connected through a channel, formed in the body, with the drain tank or sump), and on the external surface of the first-stage valve a closed cylindrical annular chamber being formed below the locking sealing surface of the valve, bounded by the internal surface of the body, a channel being formed in the body, in which a jet is installed, through which said annular chamber of the valve is constantly connected with the source of the actuating fluid, and through said distribution channel formed in the body, the chamber is connected with above-piston space of said locking piston of the nozzle needle in the open position of the first-stage valve (during injection), said closed annular chamber through an annular slot formed between the body and the valve, is connected with said drain cavity above the valve.

6. Hydraulically driven pump-injector according to claim 5, wherein the second-stage valve of the distributing device is made as a hollow cylinder with internal cavity and is disposed coaxially with the first-stage valve in the bore of the pump-injector body or in its own body, mounted in the pump-injector body (hereinafter “in the body”), having a conical locking sealing surface, a partition being made in the valve, in which bores are made connecting the internal cavity of the valve with the central channel formed under the valve in the body, said channel being constantly connected with the working above-piston cavity of the power piston; the second-stage valve has a precision guiding part adjoining the body, and a locking sealing part (conical or spherical), resting upon the appropriate said sealing surface of the body, the diameter of the locking edge of adjoining sealing surfaces of the body and valve being smaller than the diameter of the precision part of the valve, and an annular chamber being formed above the locking edge of the sealing surface in the body, which is constantly connected with the source of the actuating fluid, said chamber being disposed in such a way that when the second-stage valve opens, the actuating fluid is introduced through the annular slot formed between the body and valve, and through said central channel formed in the body, into the above-piston working cavity of the power piston.

7. Hydraulically driven pump-injector according to claim 5, wherein for implementing the return stroke of the second-stage valve, in the part of the body of the first-stage valve facing the second-stage valve, cylindrical bores are made isolated from the drain cavity under the first-stage valve, in which coaxially with the valves of the first and of the second stages in series, forming a tandem, their faces in contact, two rods of different diameters are installed and moving in the bores, said rods having precision joints with the body, a closed cavity being formed in the body near one of the faces of the larger-diameter rod facing the first-stage valve, said cavity being constantly connected through a channel formed in the body with said annular chamber of the first-stage valve, and in the contact area between the second face of the larger-diameter rod and the face of the smaller-diameter rod, a closed cavity is formed, which is constantly connected through a channel formed in the body, with said drain cavity above the first-stage valve; the second face of the smaller-diameter diameter rod resting upon said partition of the second-stage valve (the smaller-diameter rod can also be connected with the second-stage valve by a nut, forming a fork joint or another type of a swing joint with the smaller-diameter rod).

8. Hydraulically driven pump-injector according to claim 7, wherein said partition of the second-stage valve is made in the lower part of the valve above the locking (sealing) surface of the second-stage valve, and the lower part of the body of the first-stage valve, in which said rods are disposed, is disposed inside the internal cavity of the second-stage valve.

9. Hydraulically driven pump-injector according to claim 8, wherein in the body above the upper face of the second-stage valve an annular groove is made, which is constantly connected through said outlet channel formed in the body, with drain tank or sump, the annular groove being disposed in such a way, that in the closed extreme lower position (dwell position) of the second-stage valve it is connected with the internal cavity of the second-stage valve, and in the open extreme upper position of the second-stage valve, the upper face of the second-stage valve closes said annular groove in the body and thus disconnects the internal cavity of valve from said annular groove (in another embodiment, on the external surface of the second-stage valve an annular groove may be formed, which is constantly connected by bores with the internal cavity in the valve, and through which the internal cavity in said valve in its closed extreme lower position (dwell position) is connected with said annular groove in the body).

10. Hydraulically driven pump-injector according to claim 9, wherein said central channel in the body (connecting in the open position of the second-stage valve the annular chamber, disposed above the locking cone of the second-stage valve, with the above-piston cavity of the power piston) is disposed coaxially with the bore in the body, where the precision guide of the second-stage valve is moving, and on the valve after the sealing surface, on the face turned to said central channel of the body, a cylindrical or conical protrusion is made coaxially with the precision guide of the second-stage valve, fitting in said central channel.

11. Hydraulically driven pump-injector according to claim 9, wherein said central channel (connecting said annular chamber disposed above the locking surface of the second-stage valve with the above-piston cavity of the power piston in the open position of the second-stage valve), is made coaxially with the cylindrical cavity in the pump-injector body where the power piston is moving, and on the face of the power piston facing said central channel, a cylindrical or conical protrusion is made coaxially with the piston, fitting in said central channel.

12. Hydraulically driven pump-injector according to claim 11, wherein said cavity above the upper face of the larger-diameter rod is connected with said annular chamber of the first-stage valve by a connective channel formed in the body, the channel's one end being constantly connected with said annular chamber of the first-stage valve, and its second end being connected to an annular groove formed on the external cylindrical surface of the larger-diameter rod and connected by channels with said cavity above the larger-diameter rod, said groove on the rod being disposed with regard to said second end of the channel in such a way that the connection between said groove of the rod, and said channel starts after said larger-diameter rod has traveled a certain predetermined distance from the extreme lower position, in which the rod is when the second-stage valve is in the dwell position, the gap between the cylindrical surface of the rod and the body in the area above said annular groove on the rod being larger than the gap between the cylindrical surface of the rod and the body in the precision joint between the larger-diameter rod and the body disposed below the groove.

13. Hydraulically driven pump-injector according to claim 4, wherein on said face of the locking piston of the nozzle needle a protrusion is made whose cross-sectional area is smaller than the cross-sectional area of the locking piston of the needle and whose face closes said central filling channel in the body which connects the under-plunger cavity with the above-piston space of the nozzle needle when the locking piston with needle are in the extreme upper (open) position.

14. Hydraulically driven pump-injector according to claim 13, wherein said protrusion of the locking piston of the nozzle needle has cylindrical, conical or spherical form and rests upon a conical bore in the body, said central filling channel also running into said conical bore, disposed coaxially with the locking piston, the contact between said elements of the locking device (between the protrusion and conical surface of said bore of the body) being made along the bearing line that has a form of a circumference or along a conical surface, the area of the circle of a diameter of said bearing line or inner diameter of the bearing conical surface of the locking device should be smaller than the area of the differential surface of the nozzle needle (the difference in the areas of the cross-section of the precision guide and area corresponding to the locking circumference of the bearing edge of the cone of the needle), and the area of the annular cross-section (the difference in the areas of the cross-section of the locking piston and the circle corresponding to the diameter of the bearing line (or the inside diameter of the sealing cone), divided by the pressure multiplication coefficient in the pressure intensifier (ratio of the cross-section areas of the power piston and pumping plunger) must be greater than the cross-sectional area of the precision guide of the needle of the sprayer unit.

15. Hydraulically driven pump-injector according to claim 13, wherein the face of the body, in which said central filling channel ends, that connects the under-plunger cavity with said above-piston space of the locking piston of the needle, is flat, while on the flat face of the protrusion of the locking piston having a cylindrical or conical form and adjoining said flat face of the body, a cylindrical or conical bore is made coaxially with the protrusion, whose maximum inside diameter is smaller than the outer diameter of the protrusion and into which said central filling channel also runs when the locking piston with needle are in the extreme upper position, while the area of the circle corresponding to the inside diameter of said cylindrical bore of the protrusion should be smaller than the area of the differential surface of the nozzle needle (as defined in claim 14) and the difference in the areas of the cross-section of the locking piston of needle and the area corresponding to the outer diameter of the protrusion of the locking piston, divided by the pressure multiplication coefficient in the pressure intensifier (as defined in claim 14), must be greater than the cross-sectional area of the precision guide needle of the sprayer unit.

16. Hydraulically driven pump-injector according to claim 14, wherein the diameter of the central filling channel in the body, connecting the under-plunger cavity with above-piston space of the locking face of the nozzle needle is smaller than the bearing diameter of the protrusion of the locking piston of the needle (according to claim 14) or the inside diameter of the cylindrical bore of the protrusion (according to claim 15).

17. Hydraulically driven pump-injector according to claim 5, wherein the first-stage valve above the locking surface has a disk extension perpendicular to the valve axis, which serves as armature of the electromagnetic drive.
